(19) United States
(12) Patent Application Publication
(10) Pub. No.: US 2024/0299976 A1
(43) Pub. Date: Sep. 12, 2024

(54) ENHANCED THERMAL COATING (FROG SKIN) FOR MUZZLE DEVICES

(71) Applicant: Bradford Whittam Riley, Olathe, KS (US)

(72) Inventor: Bradford Whittam Riley, Olathe, KS (US)

(21) Appl. No.: 18/598,685

(22) Filed: Mar. 7, 2024

Related U.S. Application Data
(60) Provisional application No. 63/451,561, filed on Mar. 11, 2023.

(51) Int. Cl. B05D 5/02; C04B 35/622; F41A 21/02

(52) U.S. Cl. CPC B05D 5/02; C04B 35/62222; F41A 21/02; B05D 2254/02

(57) ABSTRACT

A method of manufacturing a firearm component comprising: providing a body having an exterior surface; applying a first coating layer to the exterior surface; after coating the exterior surface, affixing a granular aggregate to the exterior surface; and after affixing the aggregate, applying an additional coating layer.

### CROSS-REFERENCE TO RELATED APPLICATIONS

This application claims the benefit of U.S. Provisional Patent Application No. 63/451,561, filed on Mar. 11, 2023, entitled “ENHANCED THERMAL COATING (FROG SKIN) FOR MUZZLE DEVICES”, which is hereby incorporated by reference in its entirety for all that is taught and disclosed therein.

### FIELD OF THE INVENTION

The present invention relates to thermal coatings for muzzle devices.

### BACKGROUND AND SUMMARY

Coatings or paint has been used on muzzle devices (inc. Suppressors) to improve aesthetics, durability, and thermal control for many years.

Advances in this technology have been limited. A requirement was identified for several major improvements.

First is to improve the thermal performance by keeping more of the heat generated on the inside of the muzzle device. Second is to increase the texture or grip to improve the ability to mount and dismount the muzzle device by hand or strap wrench. The third benefit is that the textured surface reduces the amount of light reflection that occurs with traditional coatings.

The above disadvantage is addressed by a method of manufacturing a firearm component comprising: providing a body having an exterior surface; applying a first coating layer to the exterior surface; after coating the exterior surface, affixing a granular aggregate to the exterior surface; and after affixing the aggregate, applying an additional coating layer.

### BRIEF DESCRIPTION OF THE DRAWINGS

FIG. 1 is a view of the frog skin.

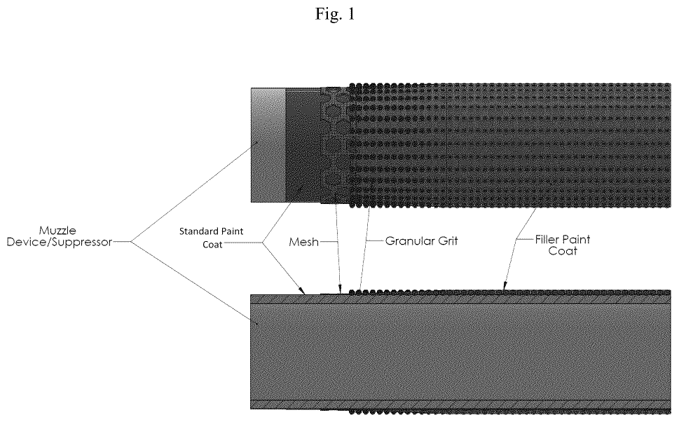

FIG. 2 is a view of the frog skin.

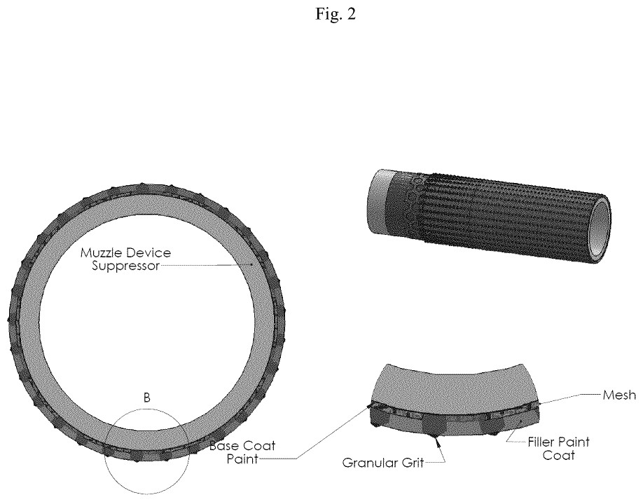

### DETAILED DESCRIPTION OF A PREFERRED EMBODIMENT

Use Coatings or paint has been used on muzzle devices (inc. Suppressors) to improve aesthetics, durability, and thermal control for many years. Advances in this technology have been limited. A requirement was identified for several major improvements. First is to improve the thermal performance by keeping more of the heat generated on the inside of the muzzle device. Second is to increase the texture or grip to improve the ability to mount and dismount the muzzle device by hand or strap wrench. The third benefit is that the textured surface reduces the amount of light reflection that occurs with traditional coatings.

The current primary coatings/paint (Cerakote) used are thin, smooth, and brittle. This invention dramatically changes the application and performance of the coatings by imbedding aggregate, filament or other materials in the coating. This acts like gravel, sand, rebar, and/or mesh in the cement making much improved and durable concrete. Using FROG SKIN results in a thicker, stronger, textured coating with a low thermal conductivity.

### Process

There are several different ways to create FROG SKIN using a combination of the following:
Base Coat, Paint/Cerakote/Epoxy.
Filler Paint Coat, Paint/Cerakote/Epoxy.
Aggregate material.
Mesh, wrap filament, felt, or cloth applied to coating or muzzle device.
Additional coating or coatings to embed the added materials partially or fully.

For example, one method we use is as follows.
Start with a suppressor that is clean.
Prepare the suppressor surface by blasting with a 80 grit media.
Blow the surface with clean dry air to remove any contaminants.
Spray the surface with a coat of paint.
Allow the paint to flash dry.
Wrap the suppressor with a filament or mesh.
Spray the surface with another heavy coat of paint.
While the paint is still wet, embed a combination of 80 and 220 grit aggregate into the paint.
Allow paint to Flash dry, holding the aggregate to the surface of the suppressor.
Spray the surface with additional coats of paint further encapsulating the aggregate to the surface of the suppressor.
As the Paint dries and shrinks the aggregate will be partially exposed.
Aggregate can include many different materials and size allowing the FROG SKIN to be customized for different application and different goals.

### Common Aggregates Material

Garnet
Aluminum Oxide
Glass
Pumice
Ceramic
Silica

### Common Aggregate Size

40 grit astm, .018″
60 grit astm, .010″
80 grit astm, .007″
120 grit astm, .005″
220+grit astm, .0025″

### Common Mesh, Wrap Filament, Felt, or Cloth Materials

Carbon fiber
Fiber Glass
Nomex
Nextel
Ceramic

By using different combinations of materials and aggregate sizes we can affect the thickness, thermal conductivity, texture and look of the FROG SKIN. If the user will be wearing gloves a large aggregate can be used for maximum grip. If a less aggressive texture is needed a smaller aggregate can be used alone or mixed with a large aggregate to produce a smoother finish yet still have the benefits of better thermal properties. This can be related again to a “Structural Concrete” with large aggregate, mesh and sand or “Brick Mortar” with only fine sand. The options are endless.

### Benefits

Improved thermal retention.
Improved grip.
Low observable.
Durability.

I claim:

1. A method of manufacturing a firearm component comprising:
providing a body having an exterior surface;
applying a first coating layer to the exterior surface;
after coating the exterior surface, affixing a granular aggregate to the exterior surface;
and after affixing the aggregate, applying an additional coating layer.

2. The firearm component of claim 1 wherein applying the coating includes applying a ceramic material.

3. The firearm component of claim 1 wherein affixing the aggregate includes affixing the aggregate a limited time after applying the first coating layer and adhering the aggregate to the first coating layer before the first coating layer is dried.

4. The firearm component of claim 1 including wrapping a mesh about the body.

5. The firearm component of claim 4 wherein the mesh is selected from materials including woven sheets, perforated sheets, non-woven sheets, felts, carbon fiber, fiberglass, Nomex, Nextel, and ceramic.

6. The firearm component of claim 4 including applying an additional coating layer after applying the mesh, and before affixing the aggregate.

7. The firearm component of claim 1 wherein affixing the aggregate is selected from steps including sprinkling the aggregate, dipping in the aggregate, and fluidized bed coating.

8. The firearm component of claim 1 wherein the aggregate is selected from materials including Garnet, Aluminum Oxide, Glass, Pumice, Ceramic and Silica.

9. The firearm component of claim 1 wherein the component is a firearm suppressor tube.

10. A firearm suppressor comprising:
a tube having an exterior surface;
a first coating layer on the exterior surface;
a granular aggregate embedded in the first coating layer; and
an additional coating layer at least in part overlaying the granular aggregate.

11. The firearm suppressor of claim 10 wherein applying the coating is a ceramic material.

12. The firearm suppressor of claim 10 including a mesh wrapped about the body.

13. The firearm suppressor of claim 12 wherein the mesh is selected from materials including woven sheets, perforated sheets, non-woven sheets, felts, carbon fiber, fiberglass, Nomex, Nextel, and ceramic.

14. The firearm suppressor of claim 12 wherein the mesh underlies the aggregate.

15. The firearm suppressor of claim 12 including an additional coating layer between the mesh and the aggregate.

16. The firearm suppressor of claim 12 wherein the aggregate is selected from materials including Garnet, Aluminum Oxide, Glass, Pumice, Ceramic and Silica.
